(19) United States
(12) Patent Application Publication
(10) Pub. No.: US 2024/0308358 A1
(43) Pub. Date: Sep. 19, 2024

(54) CONSTANT CURRENT CHARGING CIRCUIT FOR VEHICLE CONTROL MODULE ENERGY RESERVE CIRCUIT

(71) Applicant: GM GLOBAL TECHNOLOGY OPERATIONS LLC, Detroit, MI (US)

(72) Inventors: Peter Rolf IRGENS, Novi, MI (US); S.M. Nayeem HASAN, Novi, MI (US)

(21) Appl. No.: 18/121,643

(22) Filed: Mar. 15, 2023

(51) Int. Cl. B60L 53/14; B60L 50/60; H02J 7/00

(52) U.S. Cl. CPC B60L 53/14; B60L 50/60; H02J 7/007182; H02J 2310/48

(57) ABSTRACT

A vehicle power system includes a vehicle control module configured to control multiple electronic components of a vehicle, a power supply including an input coupled to receive input power from a system power source and an output coupled to supply power to the vehicle control module, and an energy reserve circuit electrically coupled with a node defined between the system power source and the power supply. The energy reserve circuit is configured to store energy to supply power to the power supply in response to a reduction in power supplied by the system power source below a threshold value. The system includes a charging circuit coupled between the energy reserve circuit and an electrical ground, the charging circuit configured to charge the energy reserve circuit with a constant current value.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to constant current charging circuits for vehicle control module energy reserve circuits.

Some vehicle control modules (e.g., electronic control units (ECUs) use an energy reserve circuit to maintain operation of the vehicle control module for several hundred milliseconds when a vehicle system voltage drops out. This energy reserve circuit includes a bulk capacitance within a range of 5 mF to 1000 mF. When uncharged, the bulk capacitance is a low impedance source which draws inrush current if directly connected to the vehicle system voltage. Conventional charging methods use series resistance to limit the inrush current, which results in long charge times, numerous resistors, and a large PCB area.

### SUMMARY

A vehicle power system includes a vehicle control module configured to control multiple electronic components of a vehicle, a power supply including an input coupled to receive input power from a system power source and an output coupled to supply power to the vehicle control module, and an energy reserve circuit electrically coupled with a node defined between the system power source and the power supply. The energy reserve circuit is configured to store energy to supply power to the power supply in response to a reduction in power supplied by the system power source below a threshold value. The system includes a charging circuit coupled between the energy reserve circuit and an electrical ground, the charging circuit configured to charge the energy reserve circuit with a constant current value.

In other features, the charging circuit includes a field-effect transistor (FET) coupled between the energy reserve circuit and the electrical ground.

In other features, the system includes a diode coupled between the energy reserve circuit and the electrical ground, the diode configured to define a current discharge path through the energy reserve circuit from the electrical ground to the input of the power supply.

In other features, the charging circuit includes a voltage reference coupled as an input to an amplifier, and the voltage reference and the amplifier are configured to control switching operation of the FET.

In other features, the power supply is configured to supply a bias voltage to the voltage reference and the amplifier.

In other features, the bias voltage is five volts.

In other features, the FET includes a gate, a source, and a drain, and the charging circuit includes a gate resistor coupled between the amplifier and a gate of the FET, and a shunt resistor coupled between the electrical ground and the source of the FET.

In other features, the voltage reference and the amplifier are configured to control switching operation of the FET to define a current charge path from the system power source to the electrical ground through the energy reserve circuit, the FET and the shunt resistor.

In other features, the amplifier is configured to bias a gate voltage of the FET to maintain a voltage drop across the shunt resistor at a value equal to the voltage reference.

In other features, the shunt resistor has a power rating of less than or equal to 0.5 W.

In other features, the energy reserve circuit includes one or more capacitors.

In other features, the one or more capacitors have a bulk capacitance value in a range of 5 mF to 1000 mF.

In other features, the charging circuit is configured to charge the energy reserve circuit to a voltage value equal to at least ninety percent of a voltage of the system power source in less than or equal to six seconds.

In other features, the charging circuit is configured to reduce charge current supplied to the energy reserve circuit to zero in response to a voltage across the energy reserve circuit being within a threshold voltage difference of a voltage of the system power source.

In other features, the power supply is configured to supply power to at least one peripheral device of the vehicle.

A method of charging an energy reserve circuit for a vehicle control module includes receiving, at an energy reserve circuit, a supply of power from a system power source of a vehicle, the energy reserve circuit configured to store energy to supply power to a power supply for a vehicle control module in response to a reduction in power supplied by the system power source below a threshold value, and charging the energy reserve circuit with a constant current value via a charging circuit, the charging circuit coupled between the energy reserve circuit and an electrical ground. The method includes discharging the energy reserve circuit to supply power from the energy reserve circuit to the power supply to maintain operation of the vehicle control module, in response to the reduction in the power supplied to the power supply by the system power source below the threshold value, and recharging the energy reserve circuit via the charging circuit, in response to the power supplied by the system power source returning to greater than or equal to the threshold value.

In other features, the charging circuit includes a field-effect transistor (FET) coupled between the energy reserve circuit and the electrical ground.

In other features, a diode is coupled between the energy reserve circuit and the electrical ground, and discharging includes discharging the energy reserve circuit via a current charge path from the electrical ground to the power supply through the diode and the energy reserve circuit.

In other features, the charging circuit includes a voltage reference is coupled as an input to an amplifier, and the method includes controlling switching operation of the FET via the voltage reference and the amplifier.

In other features, charging includes charging the energy reserve circuit to a voltage value equal to at least ninety percent of a voltage of the system power source in less than or equal to six seconds.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example embodiment of a vehicle including a constant current charging circuit for a vehicle control module energy reserve circuit;

FIG. 2 is a functional block diagram of an example embodiment of a vehicle including a vehicle control module, a power supply, an energy reserve circuit, and a constant current charging circuit;

FIG. 3 is a circuit diagram of an example embodiment of a constant current charging circuit configured to charge an energy reserve circuit for a vehicle control module;

FIG. 4 is a flowchart illustrating an example process for charging an energy reserve circuit for a vehicle control module via a constant current regulator circuit;

FIG. 5 is a flowchart illustrating an example process for supplying power from an energy reserve circuit to a power supply for a vehicle control module; and

FIG. 6 is a flowchart illustrating an example process for specifying operational parameters of a constant current charging circuit.

In the drawings, reference numbers may be reused to identify similar and/or identical elements.

### DETAILED DESCRIPTION

In some example embodiments, a circuit topology is configured to provide constant current charging, and unrestricted discharge, of an energy reserve circuit (e.g., one or more capacitors) for a vehicle control module (e.g., an electronic control unit (ECU)). The energy reserve circuit is charged by a constant current regulation circuit coupled in series with the energy reserve circuit. Charging occurs when a vehicle system voltage (e.g., V_{SYS}) is first applied to an energy reserve circuit, until a voltage across the energy reserve circuit reaches its steady state value (e.g., V_{SYS1}). If the vehicle system voltage drops out, the energy reserve circuit provides power to the vehicle control module through a diode discharge path.

Some energy reserve circuit charging methods use series resistance to limit the inrush current when a vehicle system voltage is first applied to an energy reserve circuit, which results in long charge times, numerous resistors, a large PCB area, and higher costs. Some example embodiments described herein use a constant current charging circuit with a reduced or minimal number of components (e.g., an operational amplifier, a shunt resistor, a voltage reference, and a metal-oxide semiconductor field-effect transistor (MOSFET)) to reduce a charging time of the energy reserve circuit, reduce inrush current, reduce an area occupied by the energy reserve circuit charging circuit on a printed circuit board (PCB), and lower costs. The constant current charging circuit may not require any changes to existing power supplies or logic for a vehicle control module.

In various implementations, a vehicle control module may use an energy reserve circuit to maintain operation for at least, e.g., several hundred milliseconds, if a vehicle system voltage drops out (such as due to a vehicle battery disconnection, etc.). For example, a vehicle system voltage may be provided at about twelve volts, about five volts, or any other suitable value(s). A vehicle system voltage may refer to a voltage level typically supplied to control components within a vehicle.

A constant current charging circuit may reduce a charge time of an energy reserve circuit (e.g., to generate a linear charging profile instead of a logarithmic charging profile). In various implementations, a constant charging circuit may monitor a current through a shunt resistor using a feedback circuit, such as a shunt resistor coupled between a field-effect transistor (FET) of the constant current regulator circuit and an electrical ground.

A gate of the FET may be biased to that a voltage drop across the shunt resistor matches a voltage reference (e.g., a non-inverting feedback amplifier), in order to charge the energy reserve circuit with a constant current. The voltage across a capacitor of the energy reserve circuit decreases as the energy reserve circuit charges, and the voltage across the FET increases.

A diode may be coupled between the energy reserve circuit and an electrical ground, and may be in parallel with the FET and the shunt resistor. The diode may provide a smaller voltage drop in a path for discharging the capacitor of the energy reserve circuit when needed. As another option, the energy reserve circuit capacitor(s) may be discharged through a body diode of the FET. Although a FET is described as one example herein, in other example embodiments other suitable types of switches may be used.

In various implementations, the energy reserve circuit may be discharged to provide power to any suitable load, such as a power supply (e.g., a power supply for a vehicle control module), a vehicle control module, one or more peripheral devices of the vehicle, etc. A desired or maximum charging time for the energy reserve circuit may be dictated by system level requirements, such as a requirement that the energy reserve circuit should be charged to a maximum voltage level, a voltage equal to the vehicle system voltage, a voltage level within a threshold value (e.g., at least 90%, at least 95%, at least 99%, etc.) of the vehicle system voltage, etc., within a specified time period after applying the vehicle system voltage (such as within less that five seconds, within less than six seconds, within less than ten seconds, within less than thirty seconds, etc.).

Some example embodiments may provide one or more advantages, including lower piece cost, faster charging times, reduced PCB area, a reduced number of components, a reduced power rating of components, etc. For example, while a charging circuit including an inrush limiting resistor may require a shunt resistor with a power rating of ≥1 W, some example embodiments of constant current charging circuits may use a shunt resistor having a power rating of 0.5 W or less.

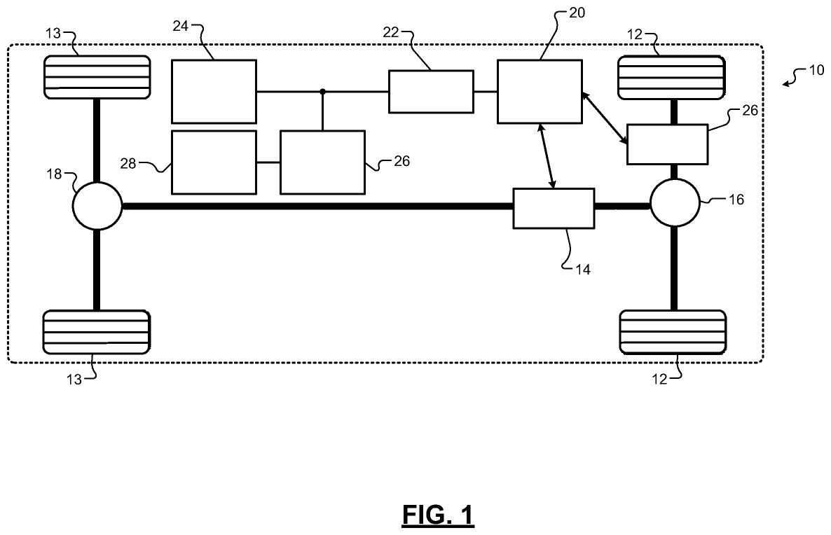

FIG. 1 is a functional block diagram of an example embodiment of a vehicle 10 including a constant current charging circuit 28 for charging an energy reserve circuit 26 for a vehicle control module 20. As shown in FIG. 1, the vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, such as one or more sensors, one or more cameras, one or more microphones, etc. The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle to vehicle (V2V) communication, vehicle to load (V2L) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks.

As shown in FIG. 1, a power supply 22 includes an output configured to supply power to the vehicle control module 20. The power supply 22 includes an input configured to receive power supplied by a system power source 24 (e.g., a battery module of the vehicle 10, a system voltage bus of the vehicle 10, etc.). The power supply 22 may include any suitable power supply voltage, and may convert input power to supplied output power at a different power level, at a higher or lower voltage, etc.

The energy reserve circuit 26 is electrically coupled with a node between the system power source 24 and the power supply 22. The energy reserve circuit 26 may be configured to store energy for suppling power to the power supply 22 in the event of a drop out or other reduction in power supplied by the system power source 24. The energy reserve circuit 26 may be configured to store enough power to maintain operation of the vehicle control module 20 for a specified time period, such as at least 100 milliseconds, at least 300 milliseconds, at least 500 milliseconds, at least one second, etc.

The constant current charging circuit 28 is coupled with the energy reserve circuit 26, to provide constant current charging for the energy reserve circuit 26. For example, the constant current charging current 28 may be configured to maintain power supplied from the system power source 24 to the energy reserve circuit 26 at a constant current level.

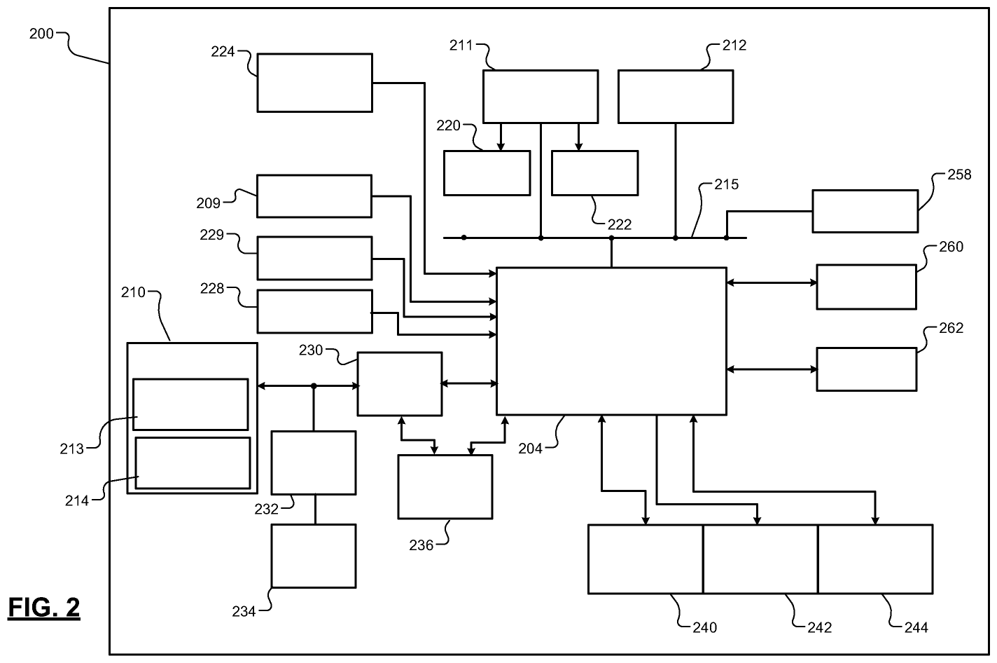

FIG. 2 is a functional block diagram of an example embodiment of a vehicle 200 including a vehicle control module 204, a power supply 230, an energy reserve circuit 232, and a constant current charging circuit 234 (which may be referred to as a constant current regulator). The vehicle 200 may be a non-autonomous, partially autonomous or fully autonomous vehicle. The vehicle 200 may be a non-electric, hybrid or fully electric vehicle. The vehicle 200 includes vehicle other sensors 209, a power source 210, an infotainment module 211 and other control modules 212. The power source 210 includes one or more battery packs (one battery pack 213 is shown) and a control circuit 214.

The vehicle sensors 209 may include temperature sensors, accelerometers, a vehicle velocity sensor, microphones, and/or other sensors. The modules 204, 211, 212 may communicate with each other and have access to a memory via one or more buses and/or network interfaces 215. The network interfaces 215 may include a controller area network (CAN) bus, a local interconnect network (LIN) bus, an auto network communication protocol bus, and/or other network bus.

The vehicle 200 may further include a display 220, an audio system 222, and one or more transceivers 224. The display 220 and/or audio system 222 may be implemented along with the infotainment module 211 as part of an infotainment system.

The vehicle 200 may further include a global positioning system (GPS) receiver 228 and a MAP module 229. The GPS receiver 228 may provide vehicle velocity and/or direction (or heading) of the vehicle and/or global clock timing information. The GPS receiver 228 may also provide vehicle location information. The MAP module 229 provides map information. The map information may include traffic control objects, routes being traveled, and/or routes to be traveled between starting locations (or origins) and destinations. The GPS receiver 228 and/or the MAP module 229 may be used to determine location of objects and position of the vehicle 200 relative to the objects. This information may also be used to determine heading information of the vehicle 200, and a relative speed of the vehicle 200.

The vehicle control module 204 may control operation of an engine 240, a converter/generator 242, a transmission 244, a brake control system 258, electric motors 260 and/or a steering system 262 according to parameters set by the modules 204, 211 and 212. The vehicle control module 204 may set some of the vehicle parameters based on signals received from the vehicle sensors 209.

The vehicle control module 204 may receive power from the power source 210, which may be provided to the engine 240, the converter/generator 242, the transmission 244, the brake control system 258, the electric motors 260 and/or the steering system 262, etc. Some of the vehicle control operations may include enabling fuel and spark of the engine 240, starting and running the electric motors 260, powering any of the systems 202, 258, 262, and/or performing other operations as are further described herein.

The engine 240, the converter/generator 242, the transmission 244, the brake control system 258, the electric motors 260 and/or the steering system 262 may include actuators controlled by the vehicle control module 204 to, for example, adjust fuel, spark, air flow, steering wheel angle, throttle position, pedal position, etc. This control may be based on the outputs of the vehicle sensors 209, the GPS receiver 228, the MAP module 229 and the above-stated data and information stored in the memory. The vehicle control module 204 may determine various parameters including a vehicle speed, an engine speed, an engine torque, a gear state, an accelerometer position, a brake pedal position, an amount of regenerative (charge) power, and/or other information.

As shown in FIG. 2, the vehicle control module 204 receives power from the power source 210 via a power supply 230. The power supply 230 may be configured to also supply power to one or more peripherals 236 of the vehicle 200. An energy reserve circuit 232 is electrically coupled with a node between the power source 210 and the power supply 230. The energy reserve circuit 232 may be charged with constant current via a constant current regulator circuit 234.

In the example embodiments of FIGS. 1 and 2, the energy reserve, peripherals and constant current regulator are illustrated outside of the control module. In various implementations, these elements may be located within one or more control modules (such as within the vehicle control module illustrated in FIGS. 1 and 2). In some example embodiments, the vehicle may include multiple control modules, and each control module may have its own energy reserve (and optionally its own corresponding constant current regulator)

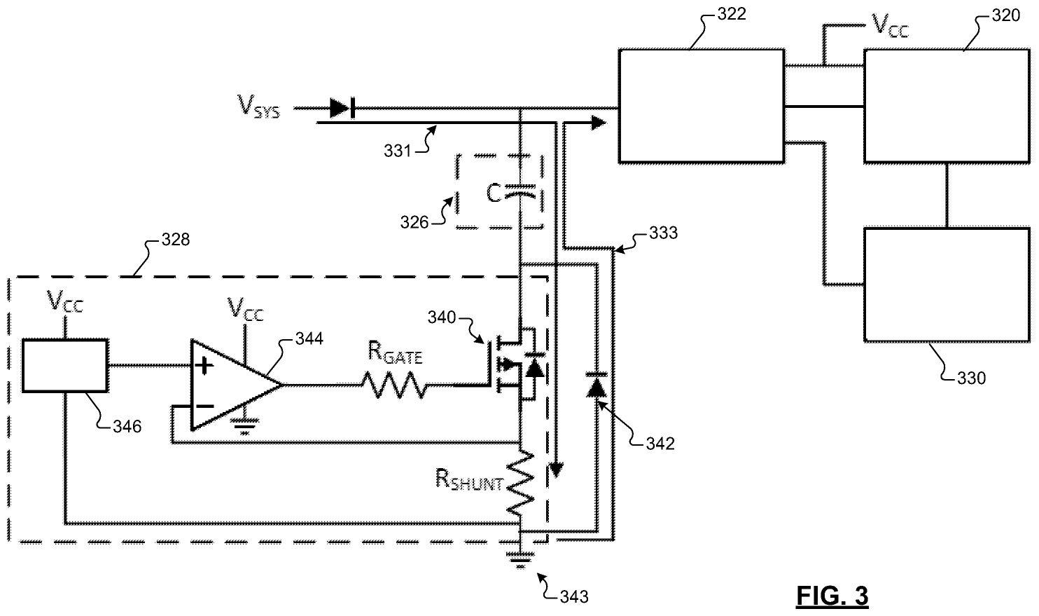

FIG. 3 is a circuit diagram of an example embodiment of a constant current charging circuit 328 configured to charge an energy reserve circuit 326 for a vehicle control module 320. As shown in FIG. 3, a power supply 322 is configured to receive a vehicle system voltage V_{SYS}, and supply power to the vehicle control module 320 (and optionally to one or more vehicle peripherals 330).

A constant charging current circuit 328 is coupled between the energy reserve circuit 326 and an electrical ground 343. The constant charging circuit includes a voltage reference 346, an operational amplifier 344, a MOSFET 340, a gate resistor R_{GATE}, and a shunt resistor R_{SHUNT}.

When a system voltage (V_{SYS}) is first applied, the energy reserve circuit 326 may not be charged (e.g., a voltage drop across a capacitor C of the energy reserve circuit 326 may be about zero volts), and the voltage drop from the drain of the MOSFET 340 to the source of the MOSFET 340 may be about equal to the system voltage. The power supply 322 beings to provide power to the vehicle control module 320, and to the constant current charging circuit 328 (such as by providing a bias voltage VCC to the voltage reference 346 and the operational amplifier 344.

The operational amplifier 344 (op-amp) biases the gate voltage (Vo) of the MOSFET 340 such that the voltage drop across the shunt resistor R_{SHUNT} is substantially equal to the reference voltage (e.g., V_{REF}=I__{CHARGE}*R__{SHUNT}). Since V_{REF} and the shunt resistance are constant, the energy reserve circuit charging current will be constant, and the op-amp will continue to bias the MOSFET 340 in the saturation region as the energy reserve circuit 326 charges (e.g., a voltage drop across the energy reserve circuit 326 rises linearly from 0V to approximately V_{SYS}).

When the voltage drop across the energy reserve circuit 326 is sufficiently close to V_{SYS} (e.g., within a threshold voltage level such as 90% of V_{SYS}, 95% of V_{SYS}, 99% of V_{SYS}, 100% of V_{SYS}), the MOSFET 340 transitions to the linear (e.g., ohmic) region, and the charging current diminishes to substantially zero amps. At this point charging may be considered as complete.

An example charge current path 331 is illustrated in FIG. 3, traveling from the vehicle system voltage through the energy reserve circuit 326, and through the MOSFET 340 and the shunt resistor of the constant current charging circuit 328 to the electrical ground 343.

A diode 342 is coupled in series with the energy reserve circuit 326, between the energy reserve circuit 326 and the electrical ground 343. The energy reserve circuit 326 is coupled in parallel with the constant current charging circuit 328 (e.g., in parallel with the MOSFET 340 and the shunt resistor of the constant current charging circuit 328).

The diode 342 may be configured to provide a low impedance (e.g., unrestricted) path for current to be supplied from the energy reserve circuit 326 to the power supply 322 and then return through the ground plane (e.g., the electrical ground 343), through the diode 342 and back to the energy reserve circuit 326. The example discharge current path 333 is illustrated in FIG. 3. Discharge current may be unrestricted (e.g., not limited), and may be dependent on loading of the power supply 322.

The energy reserve circuit 326 may be configured to discharge current to the power supply 322 in response to a drop out or reduction of the vehicle system voltage V_{SYS}. For example, the energy reserve circuit 326 may be configured to discharge current to the power supply 322 if the vehicle system voltage V_{SYS} drops below a threshold voltage value, such as below 99% of a normal voltage value of the vehicle system voltage V_{SYS} (e.g., about 12 volts), below 95% of the normal voltage value, below 90% of the normal voltage value, below 50%, down to zero, etc. The energy reserve circuit 326 may be configured to continue discharging current to the power supply 322 until the energy reserve circuit 326 runs out of stored energy, or until the vehicle system voltage returns to a value greater than or equal to the threshold voltage value. At that point, the energy reserve circuit 326 may begin recharging based on power supplied by the vehicle system voltage.

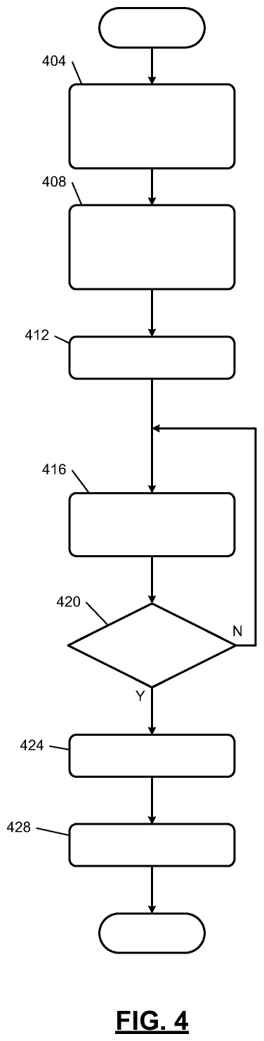

FIG. 4 is a flowchart illustrating an example process for charging an energy reserve circuit for a vehicle control module via a constant current regulator circuit. The example process may be performed by, e.g., one or more components illustrated in the circuit diagram of FIG. 3, such as the constant current charging circuit 328.

At 404, a vehicle system power source is configured to supply power while the energy reserve circuit is not charged. For example, the capacitors of the energy reserve circuit may be initially discharged (e.g., V__{C}=0V, V__{(DS_FET)}=V__{SYS1}), V__{(GS_FET)} is approximately 2.1V).

At 408, the power supply provides power to the vehicle control module and the constant current charging circuit. The op-amp biases the MOSFET gate voltage at 412, and constant current charging is provided to the energy reserve circuit by the constant current charging circuit at 416. For example, the constant current charging circuit may charge the energy reserve circuit capacitors to a mostly charged stage (e.g., V__{C}=13.4V, V__{(DS_FET)}=0.1V, V__{(GS_FET)} is approximately 2.12V).

At 420, the constant current charging circuit continues charging the energy reserve circuit with the constant current value, until the energy reserve circuit voltage reaches a fully charged state (e.g., V__{C}=13.5V, V__{(DS_FET)}=0V, V__{(GS_FET)}=V__{CC}). At that point, the MOSFET may transition to a linear region at 424. The charging current may then diminish to about zero at 428. A constant current value in the above example may be about 0.4 A, although other example embodiments may use other suitable constant current values. Resistive charging may occur after the MOSFET transitions to the linear region at 424, which may be limited by the shunt resistor.

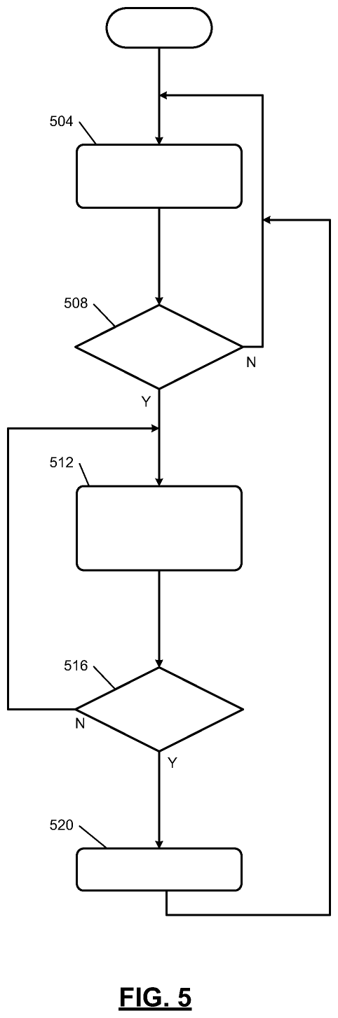

FIG. 5 is a flowchart illustrating an example process for supplying power from an energy reserve circuit to a power supply for a vehicle control module. At 504, the system voltage is supplied to the vehicle control module. The vehicle system power source continues to supply power at 508 until a system voltage drop out (e.g., reduction) occurs.

At 512, the energy reserve circuit is configured to discharge current to the vehicle control module via a diode discharge current path. The energy reserve circuit may discharge current to the power supply for maintaining a supply of power to the vehicle control module.

The energy reserve circuit continues discharging current to the vehicle control module at 516, until the vehicle system voltage returns to a threshold value (such as 90% of a normal vehicle system voltage level, 95% of the normal level, 100% of the normal level, etc.). The energy reserve circuit then begins recharging at 520.

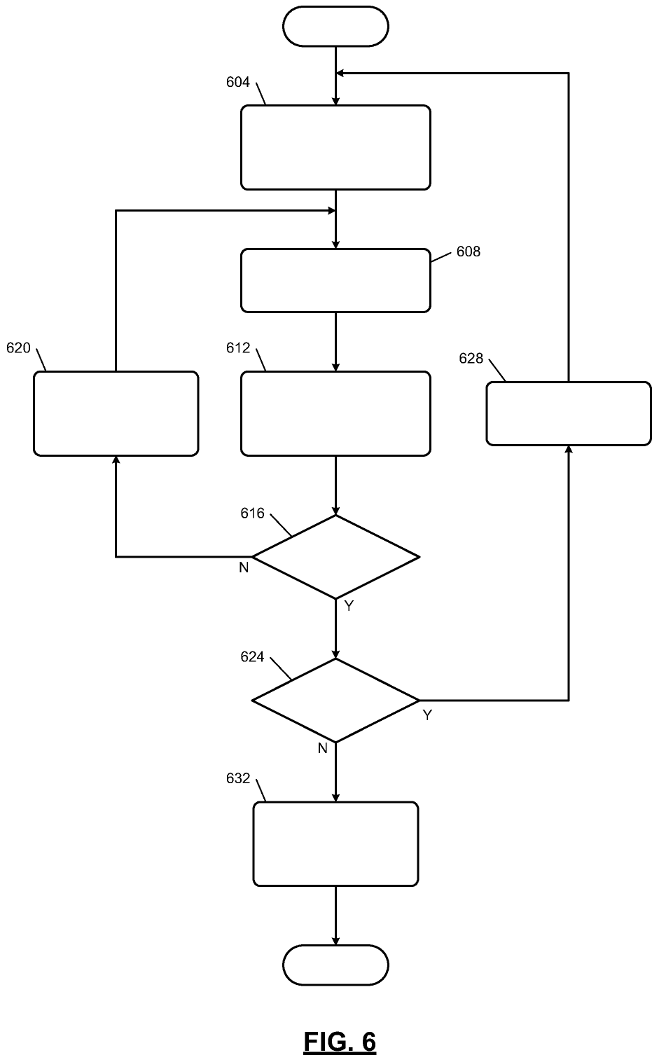

FIG. 6 is a flowchart illustrating an example process for specifying operational parameters of a constant current charging circuit. For example, assuming the energy reserve circuit bulk capacitance is already chosen/designed to ensure the that the vehicle control unit remains powered power over a duration of a system voltage (V_{SYS}) dropout period, the example process of FIG. 6 may be used to select example parameters of discrete components for the constant current charging circuit.

Let T__{(CHARGE_REQ_max)}=a maximum required charge time until the energy reserve circuit must be sufficiently charged/capable of providing energy to the vehicle control module. The maximum required charge time may be specified by requirements of the vehicle control module operation, vehicle safety requirements, etc.

Let V__{SYS}=a system voltage while charging the energy reserve circuit, and let V__{SYS1}=V__{SYS}-V__{DROP}=the system voltage at the energy reserve circuit capacitors, accounting for voltage drop from V__{SYS}. Let C=a capacitance (e.g., bulk capacitance) of the energy reserve circuit.

At 604, the example process begins by selecting a shunt resistance, a reference voltage, FET parameters, and op-amp parameters. For example, approximately 1Ω may be an example starting point for a shunt resistor. The voltage reference V__{REF} may be selected as a discrete voltage reference, a simple resistor divider from an existing voltage rail, etc.

A FET may be selected with a low gate-source threshold voltage (e.g., 1-2V or smaller). The FET gate may be biased in a sub threshold voltage region when the energy reserve circuit capacitors are close to fully charged. An op-amp may be selected with a sufficient bandwidth and input/output voltage range. During constant current charging, the op-amp output voltage=V__{REF}+V__{(GS_FET)}, where V__{(GS_FET)} is the FET gate-source bias voltage when the drain current=I__{CHARGE}. V__{(GS_FET)} will increase as the energy reserve circuit capacitors charge (e.g., the FET drain-source voltage reducing coupling with channel length modulation).

At 608, the example process includes calculating a charging current based on the selected parameters. For example, the charging current may be calculated as I__{CHARGE}=V__{REF}/R__{SHUNT}. At 612, the example process includes calculating an energy reserve circuit capacitor charge time based on the selected parameters. For example, the energy reserve circuit capacitor charge time may be calculated as T__{CHARGE}=C*V__{SYS1}/I__{CHARGE}.

At 616, the process includes checking whether the charge time is less than a threshold time. The threshold time may be a desired or maximum charge time limit requirement specified by the system, by vehicle safety requirements, etc. For example, the process may include verifying that the energy reserve circuit capacitor charge time is less than a requirement limit (T__{CHARGE}<T__{(CHARGE_REQ_max)}).

If the charge time is not less than the threshold time, the process proceeds to 620 to revise the selected parameters to increase the charging current. For example, the charge current I__{CHARGE} may be increased by reducing R__{SHUNT} or increasing V__{REF}.

At 624, the process includes determining whether any components will exceed a maximum thermal rating. For example, the process may verify through analysis whether the FET and shunt resistor are thermally capable of surviving worst case charging, and whether the discharge diode is thermally capable of surviving worst case discharging. If any component is determined as a risk of not being able to withstand worst case charging or discharging, control proceeds to 628 to select a different FET, shunt resistor and/or diode. Once all components are acceptable, the process charges the energy reserve circuit via constant current charging circuit including discrete components having the selected parameters, at 632.

Table 1 illustrates example parameters for a constant current charging circuit according to one example embodiment, as compared to a resistor charging circuit.

TABLE 1

| | | | | Constant | |
|---|---|---|---|---|---|
| | | | | Current | |
| | | | Resistor | Charging | |
| | | | Charging Circuit | Circuit | |
| | | | (conventional) | (proposed) | |
| Total Capacitance | | Max | 188.4 | 188.4 | mF |
| | | Nom | 105.0 | 105.0 | mF |
| | | Min | 50.0 | 50.0 | mF |
| Discharging | | Full Load | 50 | 50 | Ms |
| | | Derived | | | |
| | | Duration | | | |
| | | Loading | 30 | 30 | W |
| Charging | Shunt Resistance | Nom | 31.2 | 1 | Ω |
| | Charge Time to | Vsys = 12.5 V | 27.4 | 5.6 | sec |
| | Vsys1 = 90%*12.5 V | | | | |
| | (max) | | | | |
| | Peak Inrush | Vsys = 12.5 V | 0.470 | 0.452 | A |
| | Current (max) | | | | |

| | | | |
|---|---|---|---|
| BOM | Total # | 9 | 7 |
| | Components | | |
| | PCB Area | 164.71 | 37.83 |
| | (mm\hat{ }2) | | |
| | Component | $0.89 | $0.42 |
| | Cost@1M | | |

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle power system comprising:
a vehicle control module configured to control multiple electronic components of a vehicle;
a power supply including an input coupled to receive input power from a system power source and an output coupled to supply power to the vehicle control module;
an energy reserve circuit electrically coupled with a node defined between the system power source and the power supply, the energy reserve circuit configured to store energy to supply power to the power supply in response to a reduction in power supplied by the system power source below a threshold value; and
a charging circuit coupled between the energy reserve circuit and an electrical ground, the charging circuit configured to charge the energy reserve circuit with a constant current value.

2. The vehicle power system of claim 1, wherein the charging circuit includes a field-effect transistor (FET) coupled between the energy reserve circuit and the electrical ground.

3. The vehicle power system of claim 2, further comprising a diode coupled between the energy reserve circuit and the electrical ground, the diode configured to define a current discharge path through the energy reserve circuit from the electrical ground to the input of the power supply.

4. The vehicle power system of claim 3, wherein:
the charging circuit includes a voltage reference coupled as an input to an amplifier; and
the voltage reference and the amplifier are configured to control switching operation of the FET.

5. The vehicle power system of claim 4, wherein the power supply is configured to supply a bias voltage to the voltage reference and the amplifier.

6. The vehicle power system of claim 5, wherein the bias voltage is five volts.

7. The vehicle power system of claim 4, wherein the FET includes a gate, a source, and a drain, and the charging circuit includes:
a gate resistor coupled between the amplifier and a gate of the FET; and
a shunt resistor coupled between the electrical ground and the source of the FET.

8. The vehicle power system of claim 7, wherein the voltage reference and the amplifier are configured to control switching operation of the FET to define a current charge path from the system power source to the electrical ground through the energy reserve circuit, the FET and the shunt resistor.

9. The vehicle power system of claim 7, wherein the amplifier is configured to bias a gate voltage of the FET to maintain a voltage drop across the shunt resistor at a value equal to the voltage reference.

10. The vehicle power system of claim 7, wherein the shunt resistor has a power rating of less than or equal to 0.5 W.

11. The vehicle power system of claim 1, wherein the energy reserve circuit includes one or more capacitors.

12. The vehicle power system of claim 11, wherein the one or more capacitors have a bulk capacitance value in a range of 5 mF to 1000 mF.

13. The vehicle power system of claim 1, wherein the charging circuit is configured to charge the energy reserve circuit to a voltage value equal to at least ninety percent of a voltage of the system power source in less than or equal to six seconds.

14. The vehicle power system of claim 1, wherein the charging circuit is configured to reduce charge current supplied to the energy reserve circuit to zero in response to a voltage across the energy reserve circuit being within a threshold voltage difference of a voltage of the system power source.

15. The vehicle power system of claim 1, wherein the power supply is configured to supply power to at least one peripheral device of the vehicle.

16. A method of charging an energy reserve circuit for a vehicle control module, the method comprising:
receiving, at an energy reserve circuit, a supply of power from a system power source of a vehicle, the energy reserve circuit configured to store energy to supply power to a power supply for a vehicle control module in response to a reduction in power supplied by the system power source below a threshold value;
charging the energy reserve circuit with a constant current value via a charging circuit, the charging circuit coupled between the energy reserve circuit and an electrical ground;
discharging the energy reserve circuit to supply power from the energy reserve circuit to the power supply to maintain operation of the vehicle control module, in response to the reduction in the power supplied to the power supply by the system power source below the threshold value; and
recharging the energy reserve circuit via the charging circuit, in response to the power supplied by the system power source returning to greater than or equal to the threshold value.

17. The method of claim 16, wherein the charging circuit includes a field-effect transistor (FET) coupled between the energy reserve circuit and the electrical ground.

18. The method of claim 17, wherein:
a diode is coupled between the energy reserve circuit and the electrical ground; and
discharging includes discharging the energy reserve circuit via a current charge path from the electrical ground to the power supply through the diode and the energy reserve circuit.

19. The method of claim 18, wherein:
the charging circuit includes a voltage reference is coupled as an input to an amplifier; and
the method includes controlling switching operation of the FET via the voltage reference and the amplifier.

20. The method of claim 16, wherein charging includes charging the energy reserve circuit to a voltage value equal to at least ninety percent of a voltage of the system power source in less than or equal to six seconds.
